(19) United States
(12) Patent Application Publication
(10) Pub. No.: US 2014/0281497 A1
(43) Pub. Date: Sep. 18, 2014

(54) ONLINE PERSONALIZATION UPDATE SYSTEM FOR EXTERNALLY ACQUIRED KEYS

(71) Applicant: GENERAL INSTRUMENT CORPORATION, Horsham, PA (US)

(72) Inventors: Alexander Medvinsky, San Diego, CA (US); Xin Qui, San Diego, CA (US); Joel D. Voss, Elkhorn, WI (US); Ting Yao, San Diego, CA (US)

(73) Assignee: General Instrument Corporation, Horsham, PA (US)

(21) Appl. No.: 13/802,073

(22) Filed: Mar. 13, 2013

(51) Int. Cl. H04L 9/32

(52) U.S. Cl. CPC H04L 9/3263
USPC 713/156

(57) ABSTRACT

A method is provided for updating identity data on network-enabled devices. The method provides for providing certificate signing requests and/or device identifiers to an external trust authority, which in response generates digital certificates and/or key pairs. The generated digital certificates and/or key pairs can be provided to a network-enabled device in response to an update request.

### RELATED APPLICATIONS

This application is related to: co-pending U.S. application Ser. No. 12/961,455 filed on Dec. 6, 2010, entitled “Online Public Key Infrastructure (PKI) System;” co-pending U.S. application Ser. No. 13/087,843 filed on Apr. 15, 2011, entitled “Cross-Domain Identity Management for a Whitelist-Based Online Secure Device Provisioning Framework;” co-pending U.S. application Ser. No. 13/087,847 filed on Apr. 15, 2011, entitled “Online Secure Device Provisioning Framework;” and co-pending U.S. application Ser. No. 13/267,672 filed on Oct. 6, 2011, entitled “Online Secure Device Provisioning Framework.”

### BACKGROUND

1. Technical Field

The present disclosure relates to the field of digital security, particularly digital security for devices in an online personalization update system (OPUS) using externally acquired keys.

2. Background

The use and transfer of digital information has become important in many areas of life, including commerce, education, government, entertainment and management. In many of these areas, the ability to ensure the privacy, integrity and authenticity of information can be critical. As a result, several digital security mechanisms have been developed to improve security.

One approach to digital security is referred to as a Public Key Infrastructure (PKI). A PKI system uses digital certificates to authenticate information, such as the identity of a certificate holder. In a PKI system, a certificate authority (CA) issues a digital certificate to a certificate holder. A CA can create a digital certificate by digitally signing, with its own private key, identifying information submitted to the CA along with a public key of the holder who seeks the digital certificate. In some embodiments the digital certificates can have a limited period of validity, but the digital certificates can be revoked prior to the expiration of the validity period if a revocable event occurs, such as the compromise of a certificate holder's corresponding private key. In some embodiments, a digital certificate comprises a collection of information to which a digital signature is attached. A community of certificate users can trust a CA to attach its digital signature to digital certificates and issue the digital certificates to various users and/or devices within a system.

A digital certificate issued to a certificate holder can be provided to a third party as an attestation by the CA that the certificate holder named in the digital certificate is in fact the person, entity, machine, email address user, or other identifier that is set forth in the digital certificate, and that the public key in the digital certificate is, in fact, the certificate holder's public key. People, devices, processes or other entities dealing with the certificate holder can rely upon the digital certificate in accordance with the CA's certification practice statement.

A PKI system can be used by network-enabled devices to communicate with other network-enabled devices in a secure manner. By way of non-limiting examples, network-enabled devices can be PCs, mobile phones, routers, media players, set-top boxes and other devices capable of connecting to a network. Network-enabled devices can be provisioned with identity data, including a public and private key pair and a digital certificate.

The identity data can be provisioned in network-enabled devices before or after they are deployed in the field. The identity data can be incorporated into a network-enabled device in a factory during or after manufacture of the network-enabled device, and/or the identity data can be provisioned or updated in a network-enabled device after the network-enabled device has left the factory. By way of a non-limiting example, a large scale upgrade of many network-enabled devices can occur when a network operator desires to replace its Digital Rights Management (DRM) system or when it wants to support other security applications that require the network-enabled devices to be provisioned with new types of identity data after the network-enabled devices have been deployed. This can be a difficult and cumbersome process because it is often performed manually and therefore can require the devices to be returned to a service center.

### SUMMARY

An identity data management system is described herein which provides a flexible framework that can be used to add, upgrade, renew, or supplement identity data that is provisioned in a base of network-enabled devices that have already been deployed in the field. The system architecture can allow network operators to install and update the identity data in these devices without having to recall them from the end-user. The system architecture can also allow network operators to update expired or expiring digital certificates provisioned in previously deployed network-enabled devices with minimum service disruption. By way of a non-limiting example, a service provider can have acquired 500,000 units of a product that they have delivered to their end user customers, and the service provider can desire to update the identity data in all or a subset, such as 100,000, of those units. In some embodiments, the identity data can be PKI data, public keys, private keys, digital certificates, and/or other identity data. In other embodiments, the identity data can be device identifiers such as a serial number, or any other type of identity data.

In some embodiments, the system can allow network operators to install identity data on network-enabled devices already deployed in the field. By way of a non-limiting example, some network-enabled devices can have device-specific cryptographic keys bound to a non-modifiable chip ID that is gathered in a factory while the network-enabled devices are being manufactured in a production line. The list of chip IDs can be submitted to an external trust authority after the network-enabled devices have been manufactured. The external trust authority can return a list of cryptographic keys after a period of time, after which the keys can be provisioned into the network-enabled devices. By way of another non-limiting example, in OpenCable or CableCARD systems, certificates can be provisioned into host devices or CableCARDs that have already been fielded, if for example the devices did not receive certificates during manufacture or the certificates installed during manufacturing have expired. The manufacturer can generate a new set of RSA key pairs and device identifiers, and submit the public keys and device identifiers to an external trust authority along with certificate signing request files. The certificate signing request can include an RSA public key along with the device identifier as part of a certificate subject name. When the external trust authority provides a set of device certificates in response, the device certificates along with their corresponding private keys can be provisioned in the already fielded host devices or CableCARDs.

In one embodiment, the present invention includes a method for updating network-enabled devices with new identity data, the method comprising generating a key pair based on a device identifier on a whitelist, wherein the key pair comprises a public key and a private key, generating a certificate signing request for the public key, providing the certificate signing request to an external trust authority, receiving a digital certificate from the external trust authority, wherein the external trust authority issued the digital certificate based on the certificate signing request, matching the digital certificate with the key pair for the device identifier, receiving an update request from a network-enabled device linked with the device identifier, and providing the digital certificate and the key pair to the network-enabled device in response to the update request.

In another embodiment the present invention includes a method for updating network-enabled devices with new identity data, the method comprising providing a device identifier on a whitelist to an external trust authority, receiving new identity data from the external trust authority, wherein the external trust authority generates the new identity data based on the device identifier, receiving an update request from a network-enabled device linked with the device identifier, and providing the new identity data to the network-enabled device in response to the update request.

### BRIEF DESCRIPTION OF THE DRAWINGS

Further details of the present invention are explained with the help of the attached drawings in which:

FIG. 1 depicts an embodiment of an operating environment in which processes for provisioning network-enabled devices with identity data can be implemented.

FIG. 2 depicts a flow chart for a first method of installing and updating identity data on a network-enabled device.

FIG. 3 depicts a flow chart for a second method of installing and updating identity data on a network-enabled device.

FIG. 4 depicts a flow chart for a third method of installing and updating identity data on a network-enabled device.

FIG. 5 depicts a flow chart for a fourth method of installing and updating identity data on a network-enabled device.

FIG. 6 depicts a flow chart for a fifth method of installing and updating identity data on a network-enabled device.

### DETAILED DESCRIPTION

FIG. 1 depicts an embodiment of an operating environment in which the processes described herein for provisioning network-enabled devices with identity data can be implemented. Network-enabled devices can be PCs, mobile phones, routers, media players, set-top boxes and/or any other devices capable of connecting to a network. Identity data can be keys and/or digital certificates. Keys can be key pairs of paired public keys and private keys. In some embodiments, the key pairs can be used without digital certificates. In other embodiments, the public key can be included in a digital certificate. The digital certificate can comprise the public key and a device identifier for a network-enabled device. The digital certificate can be signed with a digital signature. In some embodiments, a PKI Type ID can be used to indicate the format of identity data. By way of a non-limiting example, the PKI Type ID can be a parameter indicating that the format of the identity data is keys only, or keys with a digital certificate.

The system can comprise a PKI generation system 102, one or more PKI loaders 104, a factory/service personalization server (FSPS) 106, a factory identity database 108, one or more factory programming stations 110, a PKI reaper 112, a PKI personalization database 114, a unit personalization database 116, a whitelist generator and manager (WGM) 118, an external trust authority 120, an update server 122, and/or a deployed network 124.

The PKI generation system 102 can be in communication with one or more PKI loaders 104 and the WGM 118. The PKI generation system 102 can be configured to generate and/or store identity data for network-enabled devices. In some embodiments, the PKI generation system 102 can generate key pairs of public keys and private keys, and can generate Certificate Signing Requests (CSRs) for the public keys while keeping the private keys in the archived database 128. A CSR can be a request for a digital certificate for the public key. The CSR can include the public key and a device identifier. In some embodiments, the CSRs can be in the PKCS#10 format.

The identity data created by the PKI generation system 102 can be initial identity data to be installed on network-enabled devices at a factory through the factory programming stations 110, or new identity data used to update existing network-enabled devices, such as network-enabled devices that have been authorized to use the deployed network 124. In some embodiments, the PKI generation system 102 can generate initial identity data based at least in part on device identifiers (denoted as ID-As) created and/or maintained by the PKI Generation system 102. In some embodiments, device identifiers, such as ID-A identifiers, are maintained by a Certificate Authority (CA). In some embodiments, the Certificate Authority can be a CA 128 included in the PKI generation system 102. In alternate embodiments, the Certificate Authority can be the manufacturer of the network-enabled device. In some embodiments, the PKI generation system 102 can generate new identity data and/or CSRs based at least in part on a whitelist of device identifiers received from the WGM 118.

The PKI generation system 102 can comprise an identity database 126. The identity database 126 can store device identifiers, encrypted copies of private keys, device certificates and other device identity data generated by and/or received by the PKI generation system 102. In some embodiments, the PKI generation system 102 can further comprise a Certificate Authority (CA) 128. The Certificate Authority (CA) 128 can generate and/or maintain device identifiers, such as ID-A identifiers.

The PKI loaders 104 can receive identity data from the PKI generation system 102 and load the identity data onto another component of the system, such as the FSPS 106 and/or the update server 122. In some embodiments, the PKI loader 104 can be online and the PKI generation system 102 can be offline. By way of a non-limiting example, the PKI generation system 102 can be kept offline for security or other reasons, and identity data generated by the offline PKI generation system 102 can be manually transferred to an online PKI loader 104 via removable media such as a USB flash drive. The online PKI loader 104 can then transfer the identity data to another component of the system over a secure network.

The factory/service personalization server (FSPS) 106 can be in communication with a PKI loader 104 and the factory programming stations 110. The FSPS 106 can receive device identifiers (denoted as ID-Bs) and requests for identity data for network-enabled devices from the factory programming stations 110. The device identifiers (ID-Bs) can be a serial number, Unit ID (UID), International Mobile Equipment Identity (IMEI) number, Media Access Control (MAC) address, Wide Area Network (WAN) MAC address, and/or any other identifier. The FSPS 106 can transmit the requested identity data for the network-enabled devices to the factory programming stations 110. The requested identity data transmitted to the factory programming stations 110 can be identity data received by the FSPS 106 from the PKI loader 104.

In some embodiments, the factory identity databases 108 can be in communication with the factory programming stations 110 and the unit personalization database 116. In alternate embodiments, the factory identity databases 108 can be in communication with the factory programming stations 110 and the WGM 118 directly, without an intermediate unit personalization database 116. Each factory that manufactures network-enabled devices can have or have access to one or more factory identity databases 108. The factory identity databases 108 can store device identifiers (ID-Bs) to be assigned to network-enabled devices.

The factory programming stations 110 can be in communication with one or more of the FSPS 106 and the factory identity databases 108. The factory programming stations 110 can be computers, workstations, servers, or other hardware at factories that produce network-enabled devices. The factory programming stations 110 can be configured to assign a device identifier (ID-B) from the factory identity databases 108 to each network-enabled device produced by the factory. The factory programming stations 110 can be configured to transmit a request for identity data for a network-enabled device, along with the device identifier (ID-B) for that network enabled device, to the FSPS 106. In some embodiments, the factory programming stations 110 can receive the requested identity data from the FSPS 106 and install the identity data on the network-enabled device. In alternate embodiments, the device identifier (ID-B) can be a hardware identifier, such as a chip ID that is already on the network-enabled device. In these embodiments, the device identifier (ID-B) can be retrieved by the factory programming stations 110 from each network-enabled device, be saved into the factory identity databases 108, and/or be provided to the FSPS 106. In some embodiments, more than one device identifier (ID-B) and/or type of identity data can be assigned to a single network-enabled device.

The PKI reaper 112 can be in communication with the FSPS 106 and the PKI personalization database 114. The PKI reaper 112 can receive PKI personalization related information from the FSPS 106 and transfer the PKI personalization related information to the centralized PKI personalization database 114. The PKI personalization related information can be device identifiers ID-A, ID-B, and/or PKI Type ID. In some embodiments, the PKI reaper 112 can keep track of device identifiers corresponding to cryptographic device identities, such as symmetric keys, private keys and digital certificates, provisioned into network-enabled devices at a factory. In some embodiments, the PKI reaper 112 can also keep track of device identifiers reported by the individual network-enabled devices that do not correspond to cryptographic device identities.

The PKI personalization database 114 can be in communication with the PKI reaper 112 and the WGM 118. The PKI personalization database 114 can receive PKI personalization related information from the PKI reaper 112 that the PKI reaper obtained from the FSPS 106. The PKI personalization database 114 can then the transmit PKI personalization related information to the WGM 118.

In some embodiments, the unit personalization database 116 can be in communication with the factory identity databases 108 and the WGM 118. The unit personalization database 116 can receive device identifiers (ID-B) from one or more of the factory identity databases 108. The unit personalization database 116 can transmit a list of the received device identifiers (ID-B) to the WGM 118. In alternate embodiments, the unit personalization database 116 can be absent and/or not used, such that one or more factories do not interface with the unit personalization database 116. In these embodiments, the device identifiers (ID-B) can be provided directly from the factory identity databases 108 to the WGM 118.

The whitelist generator and manager (WGM) 118 can be in communication with the PKI generation system 102, the PKI personalization database 114, the unit personalization database 116, the external trust authority 120, the update server 122, and/or the deployed network 124. The WGM 118 can receive device identifiers (such as ID-A, ID-B, ID-C, or any other device identifier) from the PKI personalization database 114, the unit personalization database 116, factory identity databases 108, and/or the deployed network 124, and consolidate the received device identifiers to generate a whitelist of device identifiers. The whitelist can be used by the PKI generation system 102 and/or the update server 122. Customers such as network operators and manufacturers can use the whitelist with the PKI generation system 102 or the update server 122 based on the upgrade requirements of the customer as described below.

In some embodiments, the WGM 118 can transmit the whitelist to the PKI generation system 102 and in response receive a list of CSRs from the PKI generation system 102. The WGM 118 can transmit the list of CSRs to the external trust authority 120, and in response receive new identity data from the external trust authority 120. The WGM 118 can transmit the new identity data generated by the external trust authority 120, along with corresponding device identifiers, to the PKI generation system 102.

In other embodiments, the WGM 118 can transmit a list of device identifiers from the whitelist directly to the external trust authority 120 and in response receive new identity data from the external trust authority 120. The WGM 118 can send the new identity data generated by the external trust authority 120, along with corresponding device identifiers, to the PKI generation system 102.

The external trust authority 120 can be in communication with the WGM 118. The external trust authority can issue identity data based on data received from the WGM 118. In some embodiments, the external trust authority 120 can receive a list of CSRs from the WGM 118. The external trust authority 120 can issue digital certificates, including public keys, for each network-enabled device on the list of CSRs and send the issued digital certificates to the WGM 118. In other embodiments, the external trust authority 120 can receive a list of device identifiers from the WGM 118. The external trust authority 120 can generate key pairs of public keys and private keys for each network-enabled device on the list of device identifiers and send the generated keys to the WGM 118. In some embodiments, the external trust authority 120 can generate and transmit key pairs without digital certificates. In alternate embodiments, the external trust authority 120 can generate a digital certificate that incorporates the key pair's public key, and can transmit the generated private key and corresponding digital certificate to the WGM 118.

The update server 122 can be in communication with the WMG 118, a PKI loader 104, and the deployed network 124. The update server 122 can receive a whitelist from the WGM 118, identity data from the PKI loader 104, and update requests from the deployed network or network enabled devices on the deployed network. Update requests can be requests for new identity data for particular network-enabled devices. In some embodiments, an update request for a particular network-enabled device can be signed with the private key installed at the factory for that network-enabled device. In some embodiments, the update server 122 can use the whitelist to verify that an update request includes a correct pairing of initial identity data installed at the factory and new identity data obtained from the external trust authority 120. The update server 122 can refuse unverified update requests and/or retried update requests that have exceeded a time limit or maximum number of attempts. If the update server 122 verifies the update request and does not reject it for exceeding a retry limit, the update server 122 can provide the network-enabled device with new identity data received via the PKI loader 104 from the PKI generation system 102.

The deployed network 124 can be a network that is accessible to the network-enabled devices. A network operator can authorize network-enabled devices received or shipped from a factory to access the deployed network 124. The network operator can assign an access account to each network-enabled device. In some embodiments, the access account can be assigned using a device identifier (denoted as ID-C) retrieved from the network operator's account/identity management system. In alternate embodiments, the access account can be assigned using a device identifier (ID-B) initially assigned to the network-enabled device at the factory for access authorization. In some embodiments, the deployed network 124 can comprise a network access authorization server. The network access authorization server can be in communication with the WGM 118. The network access authorization server can transmit a list of network-enabled devices to the WGM 118 that the network operator desires to update. In some embodiments, the list of network-enabled devices can comprise the device identifiers (ID-B and/or ID-C) for the network-enabled devices. In alternate embodiments, the list of network-enabled devices can be obtained from a factory based on a shipment notice, in which case the device identifiers can be the device identifiers ID-A and/or ID-B.

FIG. 2 depicts a flow chart for a first method of installing and updating identity data on a network-enabled device using the operating environment depicted in FIG. 1. In the method shown in FIG. 2, initial identity data can be installed on network-enabled devices at a factory, and deployed network-enabled devices can be updated with new identity data including digital certificates issued by the external trust authority 120 based on a list of CSRs.

At step 202, the PKI generation system 102 can generate initial identity data based on device identifiers (ID-As) maintained by a Certificate Authority (CA), such as the CA 128. The initial identity data can be transmitted to the FSPS 106 at a factory via a PKI loader 104. A copy of the initial identity data can also be stored in the identity database 126 within the PKI generation system 102.

At step 204, a network-enabled device can be personalized at the factory with a factory programming station 110. In some embodiments, the factory programming station 110 can retrieve a device identifier (ID-B) from the factory identity database 108 and assign the device identifier (ID-B) to the network-enabled device. In alternate embodiments, the factory programming station 110 can retrieve a device identifier (ID-B), such as a chip ID, from the network-enabled device and store the device identifier (ID-B) into the factory identity database 108. The factory programming station 110 can send a request for identity data to the FSPS 106. The request for identity data can include the device identifier (ID-B) assigned to the network-enabled device. The FSPS 106 can send initial identity data to the factory programming station 110 in response to the request for identity data. The factory programming station 110 can then install the initial identity data on the network-enabled device. In some embodiments, the factory programming station 110 can assign or install more than one type of device identifier and identity data on a single network-enabled device. By way of a non-limiting example, it can be anticipated that the network-enable device will be used for some applications that identify the network-enabled device by an IMEI number and other applications that identify the network-enabled device by a MAC address, so both type of device identifiers (ID-B) can be assigned.

At step 206, the network-enabled device can be shipped from the factory and authorized to use the deployed network by a network operator. The network operator can assign an access account to the network-enabled device. In some embodiments, the network operator can retrieve a device identifier (ID-C) from its own account/identity management system stored on the network access authorization server and use the device identifier (ID-C) to assign the access account. In alternate embodiments, the network operator can use the device identifier (ID-B), such as a WAN MAC address, assigned at the factory during step 204 to assign the access account.

At step 208, the device identifiers (ID-Bs) can be uploaded to the WGM 118 as a whitelist source. In some embodiments, the unit personalization database 116 can receive and consolidate device identifiers (ID-Bs) from one or more distributed local factory identity databases 108 at one or more factories, and upload the device identifiers (ID-Bs) to the WGM 118. In alternate embodiments, one or more distributed local factory identity databases 108 at one or more factories can directly upload the device identifiers (ID-Bs) to the WGM 118.

At step 210, the network access authorization server can transmit a list of device identifiers (ID-B and/or ID-Cs) of deployed network-enabled devices to the WGM 118 as a whitelist source. In some embodiments, the device identifiers received by the WGM 118 from the network access authorization server can be a list of device identifiers for specific network-enabled devices that a network operator or other kind of service provider desires to update with new identity data. In some embodiments, if the network operator desires to update all of the network-enabled devices on the deployed network 124, the list of device identifiers can be obtained from shipment notices from factories.

At step 212, the PKI personalization database 114 can upload personalization related information to the WGM 118 as a whitelist source. In some embodiments, personalization related information can be device identifiers such as ID-As, ID-Bs, and/or PKI Type IDs. Prior to uploading the personalization related information, the PKI personalization database 114 can have received the personalization related information from the FSPS 106 via the PKI reaper 112.

At step 214, the WGM 118 can generate a whitelist of device identifiers. The WGM 118 can consolidate the device identifiers imported into the WGM 118 during steps 208-212 to generate the whitelist. The whitelist can allow the network-enabled devices to be updated with new identity data with adequate security, as described below.

At step 216, the WGM 118 can transmit the whitelist to the PKI generation system 102. The whitelist can include the device identifiers of network-enabled devices to be updated with new identity data. Based on the whitelist, the PKI generation system 102 can generate new key pairs for each network-enabled device to be updated. The generated private keys can be encrypted and stored in the identity database 126. In some embodiments, the encryption of the private key can be performed using a previously generated public key from a digital certificate installed on the network-enabled device during step 204. The PKI generation system 102 can also generate a Certificate Signing Request (CSR) for each generated public key. The PKI generation system 102 can return a list of the CSRs, including the public keys, to the WGM 118.

At step 218, the external trust authority 120 can issue digital certificates based on the list of CSRs. The WGM 118 can transmit the list of CSRs received from the PKI generation system 102 to the external trust authority 120. The external trust authority 120 can generate and issue a digital certificate incorporating the public key for each network-enabled device for which there is a CSR on the list of CSRs received from the WGM 118. The external trust authority 120 can transmit the issued digital certificates to the WGM 118.

At step 220, the WGM 118 can transmit a list of the digital certificates issued by the external trust authority 120, along with a list of corresponding device identifiers, to the PKI generation system 102. The PKI generation system 102 can use the device identifiers corresponding to the issued digital certificates to match the newly issued digital certificates to previously generated and encrypted private keys.

At step 222, the update server 122 can receive new identity data from the PKI generation system 102 via a PKI loader 104. The new identity data can be the digital certificates and private keys matched during step 220. The update server 122 can also receive an updated whitelist from the WGM 118 that has been updated with the device identifiers corresponding to the digital certificates received from the external trust authority 120 during step 218.

At step 224, the update server 122 can receive an update request from a network-enabled device on the deployed network 124. In some embodiments, the update request can be signed with a previously generated private key installed on the network-enabled device during step 204. The update request can also include a digital certificate incorporating a device identifier and a public key installed at a factory during step 204. The update server 122 can authenticate the update request by validating its digital signature and digital certificate of the network-enabled device. If the update server 122 determines that the update request is invalid, the update request can be rejected. If the update server 122 determines that the update request is valid, the update server 122 can use the updated whitelist received during step 222 to verify that the update request includes a correct pairing of two device identifiers: a device identifier initially installed at a factory during step 204, found in a digital certificate in the update request; and a device identifier corresponding to the digital certificate generated by the external trust authority during step 220. If the update server determines that the update request includes a correct pairing of these device identifiers, the verified device identifier can be used to locate the new identity data for that device identifier received and stored in the update server's database during step 222.

At step 226, the update server 122 can transmit the new identity data located for the verified device identifier during step 224 to the network-enabled device in response to the update request. The network-enabled device can validate, decrypt, and install the new identity data received from the update server 122.

FIG. 3 depicts a flow chart for a second method of installing and updating the identity data of a network-enabled device using the operating environment depicted in FIG. 1. In the method shown in FIG. 3, initial identity data can be installed on network-enabled devices at a factory, and deployed network-enabled devices can be loaded with new identity data that includes keys generated by the external trust authority 120 based on a list of device identifiers.

At step 302, the PKI generation system 102 can generate initial identity data based on device identifiers (ID-As) maintained by a Certificate Authority (CA), such as the CA 128. The initial identity data can be transmitted to the FSPS 106 at a factory via a PKI loader 104. A copy of the initial identity data can also be stored in the identity database 126 within the PKI generation system 102.

At step 304, a network-enabled device can be personalized at the factory with a factory programming station 110. In some embodiments, the factory programming station 110 can retrieve a device identifier (ID-B) from the factory identity database 108 and assign the device identifier (ID-B) to the network-enabled device. In alternate embodiments, the factory programming station 110 can retrieve a device identifier (ID-B), such as a chip ID, from the network-enabled device and store the device identifier (ID-B) into the factory identity database 108. The factory programming station 110 can send a request for identity data to the FSPS 106. The request for identity data can include the device identifier (ID-B) assigned to the network-enabled device. The FSPS 106 can send initial identity data to the factory programming station 100 in response to the request for identity data. The factory programming station 110 can then install the initial identity data on the network-enabled device. In some embodiments, the factory programming station 110 can assign or install more than one type of device identifier and identity data on a single network-enabled device. By way of a non-limiting example, it can be anticipated that the network-enable device will be used for some applications that identify the network-enabled device by an IMEI number and other applications that identify the network-enabled device by a MAC address, so both type of device identifiers (ID-B) can be assigned.

At step 306, the network-enabled device can be shipped from the factory and authorized to use the deployed network by a network operator. The network operator can assign an access account to the network-enabled device. In some embodiments, the network operator can retrieve a device identifier (ID-C) from its own account/identity management system stored on the network access authorization server and use the device identifier (ID-C) to assign the access account. In alternate embodiments, the network operator can use the device identifier (ID-B), such as a WAN MAC address, assigned at the factory during step 304 to assign the access account.

At step 308, the device identifiers (ID-Bs) can be uploaded to the WGM 118 as a whitelist source. In some embodiments, the unit personalization database 116 can receive and consolidate device identifiers (ID-Bs) from one or more distributed local factory identity databases 108 at one or more factories, and upload the device identifiers (ID-Bs) to the WGM 118. In alternate embodiments, one or more distributed local factory identity databases 108 at one or more factories can directly upload the device identifiers (ID-Bs) to the WGM 118.

At step 310, the network access authorization server can transmit a list of device identifiers (ID-B and/or ID-Cs) of deployed network-enabled devices to the WGM 118 as a whitelist source. In some embodiments, the device identifiers received by the WGM 118 from the network access authorization server can be a list of device identifiers for specific network-enabled devices that a network operator or other kind of service provider desires to update with new identity data. In some embodiments, if the network operator desires to update all of the network-enabled devices on the deployed network 124, the list of device identifiers can be obtained from a shipment notices from factories.

At step 312, the PKI personalization database 114 can upload the personalization related information to the WGM 118 as a whitelist source. In some embodiments, personalization related information can be device identifiers such as ID-As, ID-Bs, and/or PKI Type IDs. Prior to uploading the personalization related information, the PKI personalization database 114 can have received the personalization related information from the FSPS 106 via the PKI reaper 112.

At step 314, the WGM 118 can generate a whitelist of device identifiers. The WGM 118 can consolidate the device identifiers imported into the WGM 118 during steps 308-312 to generate the whitelist. The whitelist can allow the network-enabled devices to be updated with new identity data with adequate security, as described below.

At step 316, the WGM 118 can transmit a list of device identifiers from the whitelist to the external trust authority 120. The list of device identifiers can be a list of device identifiers of network-enabled devices to be updated with new identity data. Although the whitelist maintained by the WGM 118 can comprise one or more device identifiers for each network-enabled device, the WGM 118 can provide a single device identifier for each network-enabled device to the external trust authority 120. Based on the list of device identifiers, the external trust authority can generate new identity data for each network-enabled device to be updated. In some embodiments, the new identity data can be a key pair comprising a private key and a corresponding public key. In other embodiments, the new identity data can be a private key and a corresponding digital certificate that includes a public key. In still other embodiments, the new identity data can be symmetric keys. The external trust authority 120 can transmit the generated new identity data to the WGM 118.

At step 318, the WGM 118 can transmit a list of the new identity data generated by the external trust authority 120, along with a list of corresponding device identifiers, to the PKI generation system 102. The private keys or symmetric keys generated by the external trust authority during step 316 can be encrypted by the PKI generation system 102. In some embodiments, the encryption of the private key or symmetric key can be performed using a previously generated public key from a digital certificate installed on the network-enabled device during step 304.

At step 320, the update server 122 can receive new identity data from the PKI generation system 102 via a PKI loader 104. The new identity data can be the new identity data generated by the external trust authority during step 316. The update server 122 can also receive an updated whitelist from the WGM 118 that has been updated with the device identifiers corresponding to the new identity data received from the external trust authority 120 during step 316.

At step 322, the update server 122 can receive an update request from a network-enabled device on the deployed network 124. In some embodiments, the update request can be signed with a previously generated private key installed on the network-enabled device during step 304. The update request can also include a digital certificate incorporating a device identifier and a public key installed at a factory during step 304. The update server 122 can authenticate the update request by validating its digital signature and digital certificate of the network-enabled device. If the update server 122 determines that the update request is invalid, the update request can be rejected. If the update server 122 determines that the update request is valid, the update server 122 can use the updated whitelist received during step 320 to verify that the update request includes a correct pairing of two device identifiers: a device identifier initially installed at a factory during step 304, found in a digital certificate in the update request; and a device identifier corresponding to the new identity data generated by the external trust authority during step 316. If the update server determines that the update request includes a correct pairing of these device identifiers, the verified device identifier can be used to locate the new identity data for that device identifier received and stored in the update server's database during step 320.

At step 324, the update server 122 can transmit the new identity data located for the verified device identifier during step 322 to the network-enabled device in response to the update request. The network-enabled device can validate, decrypt, and install the new identity data received from the update server 122.

FIG. 4 depicts a flow chart for a third method of installing and updating the identity data of a network-enabled device using the operating environment depicted in FIG. 1. In this embodiment, the FSPS 106, the PKI loader 104 coupled with the FSPS 106, the PKI reaper 112, and the PKI personalization database 114 can be absent from the operating environment depicted in FIG. 1. In the method shown in FIG. 4, the step of installing initial identity data on network-enabled devices at a factory can be absent, and deployed network-enabled devices can be loaded with new identity data that includes digital certificates issued by the external trust authority 120 based on a list of CSRs.

At step 402, a network-enabled device can be personalized at the factory with a factory programming station 110. In some embodiments, the factory programming station 110 can retrieve a device identifier (ID-B) from the factory identity database 108 and assign the device identifier (ID-B) to the network-enabled device. In alternate embodiments, the factory programming station 110 can retrieve a device identifiers (ID-B), such as a chip ID, from the network-enabled device and store the device identifier (ID-B) into the factory identity database 108. In some embodiments, the factory programming station 110 can assign or install more than one type of device identifier on a single network-enabled device. By way of a non-limiting example, it can be anticipated that the network-enable device will be used for some applications that identify the network-enabled device by an IMEI number and other applications that identify the network-enabled device by a MAC address, so both type of device identifiers (ID-B) can be assigned.

At step 404, the network-enabled device can be shipped from the factory and authorized to use the deployed network by a network operator. The network operator can assign an access account to the network-enabled device. In some embodiments, the network operator can retrieve a device identifier (ID-C) from its own account/identity management system stored on the network access authorization server and use the device identifier (ID-C) to assign the access account. In alternate embodiments, the network operator can use the device identifier (ID-B), such as a WAN MAC address, assigned at the factory during step 204 to assign the access account.

At step 406, the device identifiers (ID-Bs) can be uploaded to the WGM 118 as a whitelist source. In some embodiments, the unit personalization database 116 can receive and consolidate device identifiers (ID-Bs) from one or more distributed local factory identity databases 108 at one or more factories, and upload the device identifiers (ID-Bs) to the WGM 118. In alternate embodiments, one or more distributed local factory identity databases 108 at one or more factories can directly upload the device identifiers (ID-Bs) to the WGM 118.

At step 408, the network access authorization server can transmit a list of device identifiers (ID-B and/or ID-Cs) of deployed network-enabled devices to the WGM 118 as a whitelist source. In some embodiments, the device identifiers received by the WGM 118 from the network access authorization server can be a list of device identifiers for specific network-enabled devices that a network operator or other kind of service provider desires to update with new identity data.

At step 410, the WGM 118 can generate a whitelist of device identifiers. The WGM 118 can consolidate the device identifiers imported into the WGM 118 during steps 406-408 to generate the whitelist. The whitelist can allow the network-enabled devices to be updated with new identity data with adequate security, as described below.

At step 412, the WGM 118 can transmit the whitelist to the PKI generation system 102. The whitelist can include the device identifiers of network-enabled devices to be updated with new identity data. Based on the whitelist, the PKI generation system 102 can generate new key pairs for each network-enabled device to be updated. The generated private keys can be encrypted and stored in the identity database 126. In some embodiments, the encryption of the private key can be performed using a global per-model public key, called the Model Public Key, corresponding to a Model Private Key loaded onto the network-enabled device in obfuscated form as part of a software application. The PKI generation system 102 can also generate a Certificate Signing Request (CSR) for each generated public key. The PKI generation system 102 can return a list of the CSRs, including the public keys, to the WGM 118.

At step 414, the external trust authority 120 can issue digital certificates based on the list of CSRs. The WGM 118 can transmit the list of CSRs received from the PKI generation system 102 to the external trust authority 120. The external trust authority 120 can generate and issue a digital certificate incorporating the public key for each network-enabled device for which there is a CSR on the list of CSRs received from the WGM 118. The external trust authority 120 can transmit the issued digital certificates to the WGM 118.

At step 416, the WGM 118 can transmit a list of the digital certificates issued by the external trust authority 120, along with a list of corresponding device identifiers, to the PKI generation system 102. The PKI generation system 102 can use the device identifiers corresponding to the issued digital certificates to match the newly issued digital certificates to previously generated and encrypted private keys.

At step 418, the update server 122 can receive device identifiers and the corresponding new identity data from the PKI generation system 102 via a PKI loader 104. The new identity data can be the digital certificates and private keys matched during step 416.

At step 420, the update server 122 can receive an update request from a network-enabled device on the deployed network 124. In some embodiments, the update request can be checked for authorization based on one or more device identifiers previously installed on the network-enabled device during step 402. In other embodiments, the update request can be signed with a symmetric key derived from a unique device identifier and data hidden within a software application installed on the network-enabled device. In still other embodiments, the update request can be signed with an asymmetric private key. The asymmetric private key can be the Model Private Key described above with respect to step 412. The update server 122 can authenticate the update request by validating its digital signature and optionally validating a Model Certificate with a public key that corresponds to the Model Private Key. If the update server 122 determines that the update request is invalid, the update request can be rejected. If the update server 122 determines that the update request is valid, the update server 122 can locate the new identity data for that device identifier received and stored in the update server's database during step 418.

At step 422, the update server 122 can transmit the new identity data located for the device identifier during step 420 to the network-enabled device in response to the update request. The network-enabled device can validate, decrypt, and install the new identity data received from the update server 122.

FIG. 5 depicts a flow chart for a fourth method of installing and updating the identity data of a network-enabled device using the operating environment depicted in FIG. 1. In this embodiment, the FSPS 106, the PKI loader 104 coupled with the FSPS 106, the PKI reaper 112, and the PKI personalization database 114 can be absent from the operating environment depicted in FIG. 1. In the method shown in FIG. 5, the step of installing initial identity data on network-enabled devices at a factory can be absent, and deployed network-enabled devices can be loaded with new identity data that includes keys generated by the external trust authority 120 based on a list of device identifiers.

At step 502, a network-enabled device can be personalized at the factory with a factory programming station 110. In some embodiments, the factory programming station 110 can retrieve a device identifier (ID-B) from the factory identity database 108 and assign the device identifier (ID-B) to the network-enabled device. In alternate embodiments, the factory programming station 110 can retrieve a device identifier (ID-B), such as a chip ID, from the network-enabled device and store the device identifier (ID-B) into the factory identity database 108. In some embodiments, the factory programming station 110 can assign or install more than one type of device identifier on a single network-enabled device. By way of a non-limiting example, it can be anticipated that the network-enable device will be used for some applications that identify the network-enabled device by an IMEI number and other applications that identify the network-enabled device by a MAC address, so both type of device identifiers (ID-B) can be assigned.

At step 504, the network-enabled device can be shipped from the factory and authorized to use the deployed network by a network operator. The network operator can assign an access account to the network-enabled device. In some embodiments, the network operator can retrieve a device identifier (ID-C) from its own account/identity management system stored on the network access authorization server and use the device identifier (ID-C) to assign the access account. In alternate embodiments, the network operator can use the device identifier (ID-B), such as a WAN MAC address, assigned at the factory during step 204 to assign the access account.

At step 506, the device identifiers (ID-Bs) can be uploaded to the WGM 118 as a whitelist source. In some embodiments, the unit personalization database 116 can receive and consolidate device identifiers (ID-Bs) from one or more distributed local factory identity databases 108 at one or more factories, and upload the device identifiers (ID-Bs) to the WGM 118. In alternate embodiments, one or more distributed local factory identity databases 108 at one or more factories can directly upload the device identifiers (ID-Bs) to the WGM 118.

At step 508, the network access authorization server can transmit a list of device identifiers (ID-B and/or ID-Cs) of deployed network-enabled devices to the WGM 118 as a whitelist source. In some embodiments, the device identifiers received by the WGM 118 from the network access authorization server can be a list of device identifiers for specific network-enabled devices that a network operator or other kind of service provider desires to update with new identity data.

At step 510, the WGM 118 can generate a whitelist of device identifiers. The WGM 118 can consolidate the device identifiers imported into the WGM 118 during steps 506-508 to generate the whitelist. The whitelist can allow the network-enabled devices to be updated with new identity data with adequate security, as described below.

At step 512, the WGM 118 can transmit a list of device identifiers from the whitelist to the external trust authority 120. The list of device identifiers can be a list of device identifiers of network-enabled devices to be updated with new identity data. Although the whitelist maintained by the WGM 118 can comprise one or more device identifiers for each network-enabled device, the WGM 118 can provide a single device identifier for each network-enabled device to the external trust authority 120. Based on the list of device identifiers, the external trust authority can generate new identity data for each network-enabled device to be updated. In some embodiments, the new identity data can be a key pair comprising a private key and a corresponding public key. In other embodiments, the new identity data can be a private key and a corresponding digital certificate that includes a public key. In still other embodiments, the new identity data can be symmetric keys. The external trust authority 120 can transmit the generated new identity data to the WGM 118.

At step 514, the WGM 118 can transmit a list of the new identity data issued by the external trust authority 120, along with a list of corresponding device identifiers, to the PKI generation system 102. The private keys or symmetric keys generated by the external trust authority during step 512 can be encrypted by the PKI generation system 102. In some embodiments, the encryption of the private or symmetric keys can be performed using a global per-model public key, called the Model Public Key, corresponding to a Model Private Key loaded onto the network-enabled device in obfuscated form as part of a software application.

At step 516, the update server 122 can receive new identity data from the PKI generation system 102 via a PKI loader 104. The new identity data can be the new identity data generated by the external trust authority during step 512.

At step 518, the update server 122 can receive an update request from a network-enabled device on the deployed network 124. In some embodiments, the update request can be checked for authorization based on one or more device identifiers previously installed on the network-enabled device during step 502. In other embodiments, the update request can be signed with a symmetric key derived from a unique device identifier and data hidden within a software application installed on the network-enabled device. In still other embodiments, the update request can be signed with an asymmetric private key. The asymmetric private key can be the Model Private Key described above with respect to step 412. The update server 122 can authenticate the update request by validating its digital signature and optionally a Model Certificate with a public key corresponding to Model Private Key. If the update server 122 determines that the update request is invalid, the update request can be rejected. If the update server 122 determines that the update request is valid, the update server 122 can locate the new identity data for that device identifier received and stored in the update server's database during step 516.

At step 520, the update server 122 can transmit the new identity data located for the verified device identifier during step 518 to the network-enabled device in response to the update request. The network-enabled device can validate, decrypt, and install the new identity data received from the update server 122.

FIG. 6 depicts a flow chart for a fifth method of installing and updating the identity data of a network-enabled device using the operating environment depicted in FIG. 1. In the method shown in FIG. 6, initial identity data can be installed on network-enabled devices at a factory, and deployed network-enabled devices can be loaded with new identity data that includes digital certificates issued by the external trust authority 120 based on a list of CSRs, as well as new device identifiers generated by the PKI generation system 102.

At step 602, the PKI generation system 102 can generate initial identity data based on device identifiers (ID-As) maintained by a Certificate Authority (CA), such as the CA 128. The initial identity data can be transmitted to the FSPS 106 at a factory via a PKI loader 104. A copy of the initial identity data can also be stored in the identity database 126 within the PKI generation system 102.

At step 604, a network-enabled device can be personalized at the factory with a factory programming station 110. In some embodiments, the factory programming station 110 can retrieve a device identifier (ID-B) from the factory identity database 108 and assign the device identifier (ID-B) to the network-enabled device. In alternate embodiments, the factory programming station 110 can retrieve a device identifier (ID-B), such as a chip ID, from the network-enabled device and store the device identifier (ID-B) into the factory identity database 108. The factory programming station 110 can send a request for identity data to the FSPS 106. The request for identity data can include the device identifier (ID-B) assigned to the network-enabled device. The FSPS 106 can send initial identity data to the factory programming station 100 in response to the request for identity data. The factory programming station 110 can then install the initial identity data on the network-enabled device. In some embodiments, the factory programming station 110 can assign or install more than one type of device identifier and identity data on a single network-enabled device. By way of a non-limiting example, it can be anticipated that the network-enable device will be used for some applications that identify the network-enabled device by an IMEI number and other applications that identify the network-enabled device by a MAC address, so both type of device identifiers (ID-B) can be assigned.

At step 606, the network-enabled device can be shipped from the factory and authorized to use the deployed network by a network operator. The network operator can assign an access account to the network-enabled device. In some embodiments, the network operator can retrieve a device identifier (ID-C) from its own account/identity management system stored on the network access authorization server and use the device identifier (ID-C) to assign the access account. In alternate embodiments, the network operator can use the device identifier (ID-B), such as a WAN MAC address, assigned at the factory during step 604 to assign the access account.

At step 608, the device identifiers (ID-Bs) can be uploaded to the WGM 118 as a whitelist source. In some embodiments, the unit personalization database 116 can receive and consolidate device identifiers (ID-Bs) from one or more distributed local factory identity databases 108 at one or more factories, and upload the device identifiers (ID-Bs) to the WGM 118. In alternate embodiments, one or more distributed local factory identity databases 108 at one or more factories can directly upload the device identifiers (ID-Bs) to the WGM 118.

At step 610, the network access authorization server can transmit a list of device identifiers (ID-B and/or ID-Cs) of deployed network-enabled devices to the WGM 118 as a whitelist source. In some embodiments, the device identifiers received by the WGM 118 from the network access authorization server can be a list of device identifiers for specific network-enabled devices that a network operator or other kind of service provider desires to update with new identity data. In some embodiments, if the network operator desires to update all of the network-enabled devices on the deployed network 124, the list of device identifiers can be obtained from shipment notices from factories.

At step 612, the PKI personalization database 114 can upload personalization related information to the WGM 118 as a whitelist source. In some embodiments, personalization related information can be device identifiers such as ID-As, ID-Bs, and/or PKI Type IDs. Prior to uploading the personalization related information, the PKI personalization database 114 can have received the personalization related information from the FSPS 106 via the PKI reaper 112.

At step 614, the WGM 118 can generate a whitelist of device identifiers. The WGM 118 can consolidate the device identifiers imported into the WGM 118 during steps 208-212 to generate the whitelist. The whitelist can allow the network-enabled devices to be updated with new identity data with adequate security, as described below.

At step 616, the WGM 118 can transmit the whitelist to the PKI generation system 102. The whitelist can include the device identifiers of network-enabled devices to be updated with new identity data. Based on the whitelist, the PKI generation system 102 can generate new key pairs for each network-enabled device to be updated. The generated private keys can be encrypted and stored in the identity database 126. In some embodiments, the encryption of the private key can be performed using a digital certificate installed on the network-enabled device during step 204, which can be determined using a device identifier from the whitelist. The PKI generation system 102 can also generate a Certificate Signing Request (CSR) for each generated public key. The PKI generation system 102 can further generate new device identifiers for each network-enabled device to be updated. The PKI generation system 102 can return a list of the new device identifiers and a list of the CSRs, including the public keys, to the WGM 118.

At step 618, the external trust authority 120 can issue digital certificates based on the list of CSRs. The WGM 118 can transmit the list of CSRs received from the PKI generation system 102 to the external trust authority 120. The external trust authority 120 can generate and issue a digital certificate incorporating the public key for each network-enabled device for which there is a CSR on the list of CSRs received from the WGM 118. The external trust authority 120 can transmit the issued digital certificates to the WGM 118.

At step 620, the WGM 118 can transmit a list of the digital certificates issued by the external trust authority 120, along with a list of corresponding device identifiers, to the PKI generation system 102. The PKI generation system 102 can use the device identifiers corresponding to the issued digital certificates to match the newly issued digital certificates to previously generated and encrypted private keys.

At step 622, the update server 122 can receive new identity data from the PKI generation system 102 via a PKI loader 104. The new identity data can be the digital certificates and private keys matched during step 620, and the new device identifiers generated during step 616. The update server 122 can also receive an updated whitelist from the WGM 118 that has been updated with the device identifiers corresponding to the digital certificates received from the external trust authority 120 during step 618, and the initial device identifiers (ID-As) generated during step 602.

At step 624, the update server 122 can receive an update request from a network-enabled device on the deployed network 124. In some embodiments, the update request can be signed with a previously generated private key installed on the network-enabled device during step 604. The update request can also include a digital certificate incorporating a device identifier and a public key installed at a factory during step 604. The update server 122 can authenticate the update request by validating its digital signature and/or digital certificates. If the update server 122 determines that the update request is invalid, the update request can be rejected. If the update server 122 determines that the update request is valid, the update server 122 can use the updated whitelist received during step 622 to determine the new device identifier and then locate the new identity data for that device identifier received and stored in the update server's database during step 622.

At step 626, the update server 122 can transmit the new identity data located for the verified device identifier during step 624 and the new device identifier generated during step 616 to the network-enabled device in response to the update request. The network-enabled device can validate, decrypt, and install the new identity data and device identifier received from the update server 122.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed:

1. A method for updating identity data on network-enabled devices, comprising:
generating initial identity data for a network-enabled device based on a first device identifier;
installing said initial identity data and determining one or more second device identifiers associated with said network-enabled device;
receiving at least one of said first and second device identifiers at a whitelist manager, each of said first and second device identifiers corresponding to one of a plurality of network-enabled devices;
generating a whitelist with said whitelist manager, said whitelist comprising at least one of said first and second device identifiers for one or more of said plurality of network-enabled devices that are to be updated with new identity data;
transmitting said whitelist from said whitelist manager to a PKI generation system;
generating a key pair with said PKI generation system for each of said device identifiers on said whitelist, wherein said key pair comprises a public key and a private key;
generating a certificate signing request for each said public key with said PKI generation system;
transmitting said key pairs and said certificate signing requests from said PKI generation system to said whitelist manager;
providing said certificate signing requests from said whitelist manager to an external trust authority;
receiving digital certificates from said external trust authority at said whitelist manager, wherein said external trust authority issued said digital certificates based on said certificate signing requests;
matching said digital certificates with said whitelist manager to said key pairs for each of said device identifiers to obtain new identity data for each of said device identifiers; and
providing said new identity data for an individual network-enabled devices to said individual network-enabled device when said individual network-enabled device transmits an update request.

2. The method of claim 1, wherein said update request from said individual network-enabled device comprises at least one of said first and second device identifiers corresponding to said individual network-enabled device and said new identity data matches said device identifier in said update request.

3. The method of claim 1, further comprising:
generating new device identifiers with said PKI generation system; and
providing said new device identifiers to said network-enabled devices in response to said update requests.

4. The method of claim 1, further comprising:
updating said whitelist at said whitelist manager after said new identity data is received; and
transmitting said new identity data and said updated whitelist to an update server,
wherein said update server provides said new identity data to said individual network-enabled device when said update request is received by said update server.

5. The method of claim 1, wherein said new identity data provided to said individual network-enabled device replaces initial identity data previously installed on said network-enabled devices at factories.

6. The method of claim 1, wherein said new identity data provided to said individual network-enabled device is the first identity data to be loaded onto said individual network-enabled device.

7. The method of claim 1, wherein said whitelist is generated by said whitelist manager by consolidating said at least one of said first and second device identifiers received by said whitelist manager from a plurality of sources.

8. The method of claim 7, wherein one of said plurality of sources is a unit personalization database.

9. The method of claim 7, wherein one of said plurality of sources is a factory identity database.

10. The method of claim 7, wherein one of said plurality of sources is a network access authorization server.

11. The method of claim 7, wherein one of said plurality of sources is a PKI personalization server.

12. The method of claim 1, further comprising
encrypting said key pair generated with said PKI generation system based on a public key already installed on said individual network-enabled device.

13. A method for updating identity data on network-enabled devices, comprising:
generating initial identity data for a network-enabled device based on a first device identifier;
installing said initial identity data and determining one or more second device identifiers associated with said network-enabled device;
receiving at least one of said first and second device identifiers at a whitelist manager, each of said first and second device identifiers corresponding to one or a plurality of network-enabled devices;
generating a whitelist with said whitelist manager, said whitelist comprising at least one of said first and second device identifiers for one or more of said plurality of network-enabled devices that are to be updated with new identity data;
transmitting said whitelist from said whitelist manager to an external trust authority;
receiving said new identity data at said whitelist manager from said external trust authority, wherein said external trust authority generated said new identity data based on said first and second device identifiers on said whitelist; and
providing said new identity data for individual network-enabled devices to said individual network-enabled device when each said individual network-enabled device transmits an update request.

14. The method of claim 13, wherein said new identity data is a key pair comprising a public key and a private key.

15. The method of claim 13, wherein said new identity data is a private key and a digital certificate comprising a public key corresponding to said private key.

16. The method of claim 13, further comprising:
transmitting said new identity data from said whitelist manager to a PKI generation system;
encrypting said new identity data with said PKI generation system based on a public key already installed on said individual network-enabled device.

17. The method of claim 13, wherein said update request from said individual network-enabled device comprises at least one of said first and second device identifiers corresponding to said individual network-enabled device and said new identity data matches said device identifier in said update request.

18. The method of claim 13, wherein said new identity data provided to said individual network-enabled device replaces initial identity data previously installed on said network-enabled devices at factories.

19. The method of claim 13, wherein said new identity data provided to said individual network-enabled device is the first identity data to be loaded onto said individual network-enabled device.

20. The method of claim 13, wherein said whitelist is generated by said whitelist manager by consolidating at least one of said first and second device identifiers received by said whitelist manager from a plurality of sources.

21. A method for updating identity data on network-enabled devices, comprising:
generating initial identity data for a network-enabled device based on a first device identifier;
installing said initial identity data and determining one or more second device identifiers associated with said network-enabled device;
receiving at least one of said first and second identifiers at a whitelist manager, each of said first and second device identifiers corresponding to one of a plurality of network-enabled devices;
generating a whitelist with said whitelist manager, said whitelist comprising at least one of said first and second device identifiers for one or more of said plurality of network-enabled devices;
determining which of said one or more network-enabled devices are to be updated with new identity data;
requesting said new identity data for one or more of said network-enabled devices that are to be updated from an external trust authority based on said whitelist;
receiving said new identity data for one or more of said network-enabled devices that are to be updated from said external trust authority;
providing said new identity data to one or more of said network-enabled devices that are to be updated.

22. A method for updating identity data on network-enabled devices, comprising:
generating initial identity data for a network-enabled device based on a first device identifier;
installing said initial identity data and one or more second device identifiers on a network-enabled device;
authorizing said network-enabled device to access a network based on a third device identifier;
transmitting said first device identifier, said second device identifier, and said third device identifier to a whitelist manager;
generating a whitelist with said whitelist manager, said whitelist comprising one or more of said first, second and third device identifiers for each of one or more said network-enabled devices that are to be updated with new identity data;
transmitting said whitelist from said whitelist manager to a PKI generation system;
generating a key pair with said PKI generation system for each of said device identifiers on said whitelist, wherein said key pair comprises a public key and a private key;
generating a certificate signing request for each said public key with said PKI generation system;
transmitting said key pairs and said certificate signing requests from said PKI generation system to said whitelist manager;
providing said certificate signing requests from said whitelist manager to an external trust authority;
receiving digital certificates from said external trust authority at said whitelist manager, wherein said external trust authority issued said digital certificates based on said certificate signing requests;
matching said digital certificates with said whitelist manager to said key pairs for each of said device identifiers to obtain said new identity data for each of said device identifiers;
encrypting said new identity data with said PKI generation system using keys already installed in said one or more network enabled devices; and
providing said new identity data for an individual one of said network-enabled devices to said individual network-enabled device when said individual network-enabled device transmits an update request.

23. The method of claim 22,
wherein the first device identifier is an ID-A identifier which is a public key sequence number identifier managed by a trusted authority supplier;
wherein the second device identifier is an ID-B identifier which is a serial number specific to the individual network enabled device; and
wherein the third device identifier is an ID-C identifier which is uniquely assigned to the individual network-enabled device and then provided to the whitelist manager by a system operator.
